(19) United States
(12) Patent Application Publication
(10) Pub. No.: US 2015/0127525 A1
(43) Pub. Date: May 7, 2015

(54) DYE PACH: SYSTEMS AND METHODS FOR ACH FUND TRACKING

(71) Applicants: Brad Wardman, Scottsdale, AZ (US); Ryan C. Beutler, Phoenix, AZ (US)

(72) Inventors: Brad Wardman, Scottsdale, AZ (US); Ryan C. Beutler, Phoenix, AZ (US)

(73) Assignee: EBAY INC., San Jose, CA (US)

(21) Appl. No.: 14/132,535

(22) Filed: Dec. 18, 2013

Related U.S. Application Data
(60) Provisional application No. 61/901,355, filed on Nov. 7, 2013.

(51) Int. Cl. G06Q 20/02

(52) U.S. Cl. CPC G06Q 20/023
USPC 705/39

(57) ABSTRACT

When an Automated Clearing House (ACH) fund transaction is deemed to have suspicious nature, the ACH transfer file for the transaction may be marked with a unique key (dye pACH). The unique key may be used to track the transfer paths of funds through a plurality of financial institutions. Thus, the suspicious ACH fund may be tracked through the plurality of financial institutions. Law enforcement entities, such as police or Federal Bureau of Investigation (FBI) may use the unique key to track suspicious fund transfers through a plurality of financial institutions to detect money laundering or fraud activities or obtain high-level understanding of cybercrime organizations.

### CROSS REFERENCE TO RELATED APPLICATION

Pursuant to 35 U.S.C. §119(e), this application claims priority to the filing date of U.S. Provisional Patent Application Ser. No. 61/901,355, filed Nov. 7, 2013, which is incorporated by reference in its entirety.

### BACKGROUND

1. Field of the Invention

The present invention generally relates to systems and methods for Automated Clearing House (ACH) fund tracking.

2. Related Art

With the globalization of commerce, money laundering and fraud have become worldwide problems. Criminals are using large money transfers to launder money. With increasing volumes of electronic fund transfers, it has become more difficult for financial institutions to keep track of the source and flow of these transfers. In particular, a fund may be transferred through a plurality of financial institutions using ACH. Because the fund is not tracked through the plurality of financial institutions, criminals may use the ACH transaction system to launder money. Therefore, there is a need for a system or method that facilitates tracking of funds in the ACH system.

### BRIEF DESCRIPTION OF THE FIGURES

FIG. 1 is a block diagram of a networked system suitable for implementing an ACH fund tracking process according to an embodiment.

FIG. 2 is a flowchart showing a process for receiving an ACH transaction according to one embodiment.

FIG. 3 is a flowchart showing a process for sending an ACH transaction according to one embodiment.

FIG. 4 is a block diagram of a computer system suitable for implementing one or more components in FIG. 1 according to one embodiment.

FIG. 5 illustrates data structure of an ACH transfer file according to one embodiment.

FIG. 6 is a diagram illustrating transfers of funds through various financial institutions according to one embodiment.

FIG. 7 illustrates a data format of a file header record according to one embodiment.

FIG. 8 illustrates a data format of a batch header record according to one embodiment.

FIG. 9 illustrates a data format of an entry detail record according to one embodiment.

Embodiments of the present disclosure and their advantages are best understood by referring to the detailed description that follows. It should be appreciated that reference numerals are used to identify respective elements illustrated in one or more of the figures, wherein showings therein are for purposes of illustrating embodiments of the present disclosure and not for purposes of limiting the same.

### DETAILED DESCRIPTION

According to an embodiment, when an ACH fund transaction is deemed to have suspicious nature, the ACH transfer file for the transaction may be marked with a unique key (dye pACH). The unique key may continue to track the transfer paths of funds through a plurality of financial institutions. Thus, the suspicious ACH fund may be tracked through the plurality of financial institutions. Law enforcement entities, such as police or Federal Bureau of Investigation (FBI) may use the unique key to track suspicious fund transfers through a plurality of financial institutions to detect money laundering or fraud activities or obtain high-level understanding of cyber-criminal activities.

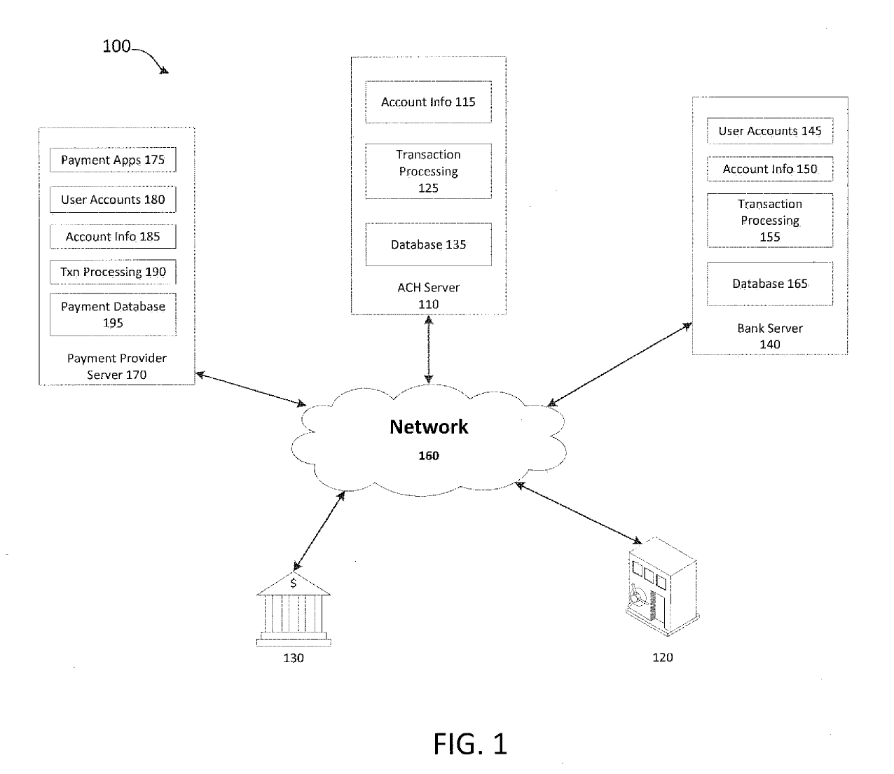

FIG. 1 is a block diagram of a networked system 100 suitable for implementing a process for facilitating ACH fund tracking according to an embodiment. Networked system 100 may comprise or implement a plurality of servers and/or software components that operate to perform various payment transactions or processes. Exemplary servers may include, for example, stand-alone and enterprise-class servers operating a server OS such as a MICROSOFT® OS, a UNIX® OS, a LINUX® OS, or other suitable server-based OS. It can be appreciated that the servers illustrated in FIG. 1 may be deployed in other ways and that the operations performed and/or the services provided by such servers may be combined or separated for a given implementation and may be performed by a greater number or fewer number of servers. One or more servers may be operated and/or maintained by the same or different entities.

System 100 may include a payment provider server 170, an ACH server 110, and bank servers 120, 130, and 140 in communication over a network 160. Payment provider server 170 may be maintained by a payment service provider, such as PayPal, Inc. of San Jose, Calif. An account user of the payment provider server 170 may utilize payment provider server 170 to perform fund transactions, such as purchase payments. The account user may initiate a payment transaction, receive a transaction approval request, or reply to the request. Note that transaction, as used herein, refers to any suitable fund transaction, including payments, transfer of information, display of information, etc. For example, the account user may initiate a deposit into a saving account at a bank.

ACH server 110 may be operated by National Automated Clearing House Association (NACHA), which coordinates electronic fund transactions among member financial institutions. Each of bank servers 120, 130, and 140 and payment provider server 170 may be operated by respective NACHA members. Thus, ACH server 110 may facilitate ACH fund transfers among payment provider server 170 and bank servers 120, 130, and 140. For example, ACH server 110 may facilitate fund transfer between a fund sending bank and a fund receiving bank. The fund sending bank may generate an ACH file including entries of fund transactions. Each entry may include information regarding the sending account, transfer amount, receiving account, and the like. The fund sending bank may send the ACH file to the ACH server 110. The ACH server 110 may process the ACH file by balancing and validating the entries of fund transactions in the ACH file. The ACH server then may sort and distribute the entries of fund transactions to respective receiving banks. The receiving banks then may receive the ACH file and may distribute funds to respective accounts designated in the ACH file.

Payment provider server 170, ACH server 110, and bank servers 120, 130, and 140 may each include one or more processors, memories, and other appropriate components for executing instructions such as program code and/or data stored on one or more computer readable mediums to implement the various applications, data, and steps described herein. For example, such instructions may be stored in one or more computer readable media such as memories or data storage devices internal and/or external to various components of system 100, and/or accessible over network 160.

Network 160 may be implemented as a single network or a combination of multiple networks. For example, in various embodiments, network 160 may include the Internet or one or more intranets, landline networks, wireless networks, and/or other appropriate types of networks.

ACH server 110 may be operated and maintained by NACHA. ACH server 110 may include account information 115 associated with members of NACHA, such as financial institutions, banks, payment service providers, and etc. Each NACHA member may be registered with NACHA and have a unique ACH identification, e.g., routing number. ACH server 110 also may include a transaction processing unit 125 configured to process ACH transactions. For example, transaction processing unit 125 may receive an ACH file from a financial institution and may balance and validate transaction entries in the ACH file. Transaction processing unit 125 may sort and send the appropriate entries in respective ACH files to respective financial institutions. ACH server 110 also may include a database 135 configured to store transaction records processed by the ACH server 110.

Payment provider server 170 may be maintained, for example, by an online payment service provider which may provide fund transfer between a payer and a payee. In this regard, payment provider server 170 may include one or more payment applications 175 which may be configured to interact with a payer or a payee's device over network 160 to facilitate the purchase of goods or services, communicate/display information, and send payments by the payee or the payer.

Payment provider server 170 also maintains a plurality of user accounts 180, each of which may include account information 185 associated with consumers, merchants, and funding sources, such as banks or credit card companies. For example, account information 185 may include private financial information of users of devices such as account numbers, passwords, device identifiers, user names, phone numbers, credit card information, bank information, or other financial information which may be used to facilitate online transactions by a user.

A transaction processing application 190, which may be part of payment application 175 or separate, may be configured to receive information from a payee or a payer for processing and storage in a payment database 195. Transaction processing application 190 may include one or more applications to process information from a user for processing an order and payment using various selected funding instruments, including for initial purchase and payment after purchase as described herein. As such, transaction processing application 190 may store details of an order from individual users, including funding source used, credit options available, etc. Payment application 175 may be further configured to determine the existence of and to manage accounts for a user, as well as create new accounts if necessary.

Bank server 140 may be maintained, for example, by a bank or a financial institution offering fund transaction services. The bank may have a physical point-of-sale (POS) store front. The bank may be a participating member of NACHA. Bank server 140 may be used for POS or online purchases and transactions. Generally, bank server 140 may be maintained by anyone or any entity that performs fund transfers. Bank server 140 may include user accounts 145 associated with users registered to conduct banking service at the bank. The users may include individuals, companies, organizations, merchants, and etc. Each of user accounts 145 may include account information 150 associated with each account user. Account information 150 may include private financial information of each account user, such as account numbers, passwords, user names, phone numbers, or other financial information which may be used to facilitate banking by a user.

Bank server 140 also may include a transaction processing unit 155 configured to process fund transfers. In particular, transaction processing unit 155 may send funds from a user's account to another account within or outside the bank. For example, transaction processing unit 155 may generate an ACH file including transaction entries instructing specific funding transfers and send the ACH file to the ACH server 110 to process fund transfer. Further, transaction processing unit 155 also may receive an ACH file from the ACH server 110 and may process transaction entries in the received ACH file and deposit funds to designated accounts. Bank server 140 may have a database 165 configured to store previous fund transactions. In particular, records of fund transactions may be stored at database 165 for record keeping purposes.

Bank servers 120 and 130 may include similar components and functions as bank sever 140. Bank servers 120 and 130 may be operated by other financial institutions that are NACHA members. Bank servers 120 and 130 are configured to receive fund transfer by receiving ACH files from ACH server 110. Bank server 120 and 130 may process transaction entries in the received ACH files and deposit funds to designated accounts according to the ACH files.

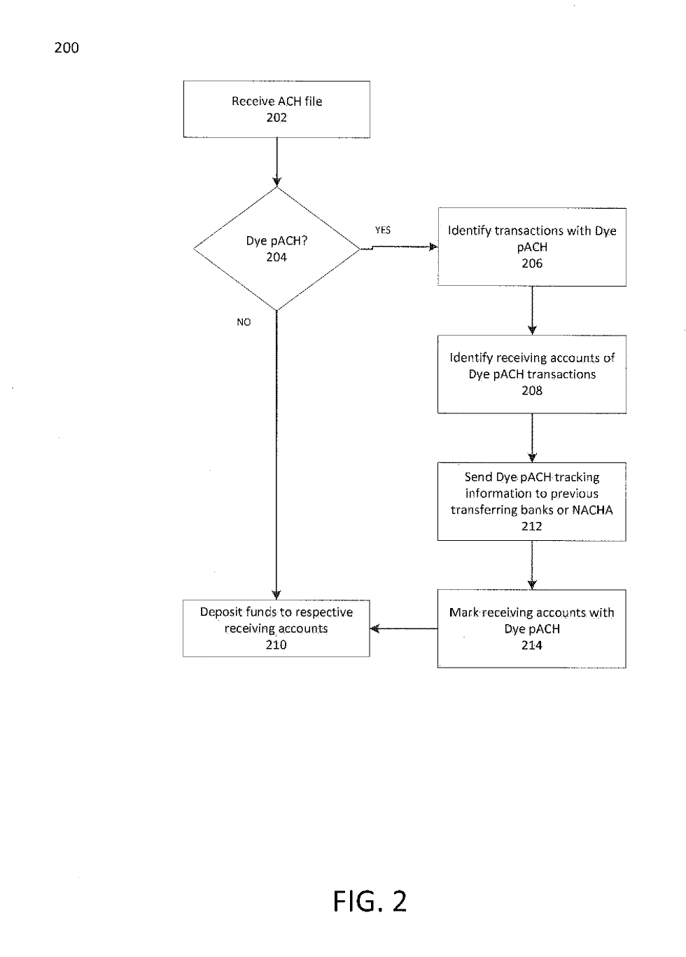

FIG. 2 is a flowchart showing a process 200 for receiving an ACH transaction according to one embodiment. Process 200 may be executed by a server of a financial institution that is a participating member of the dye pACH tracking program. For example, each of bank server 120, 130, and 140, and payment provider server 170 may execute process 200 to receive an ACH file with dye pACH markings. At step 202, a receiving bank may receive an ACH file from NACHA. For example, a bank server of the receiving bank may receive the ACH file from an ACH server of NACHA electronically via a network. The ACH file may include transaction entries each indicating a fund transfer from a sending bank to a specific account at the receiving bank.

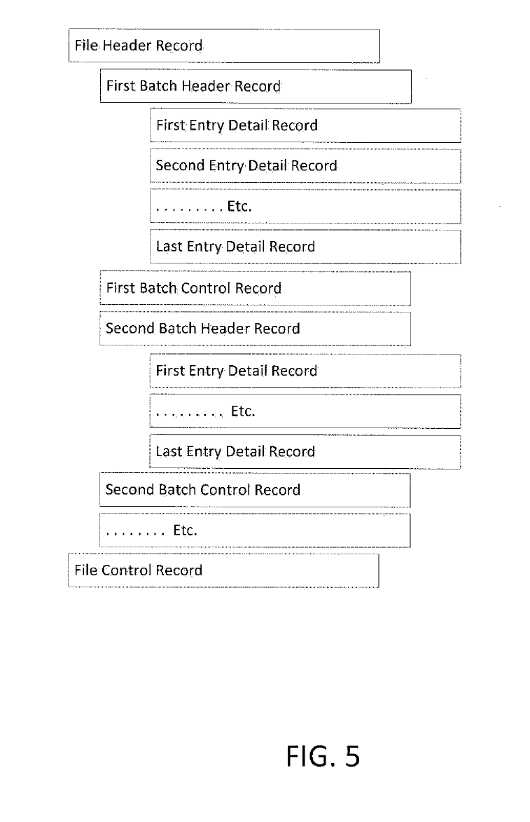

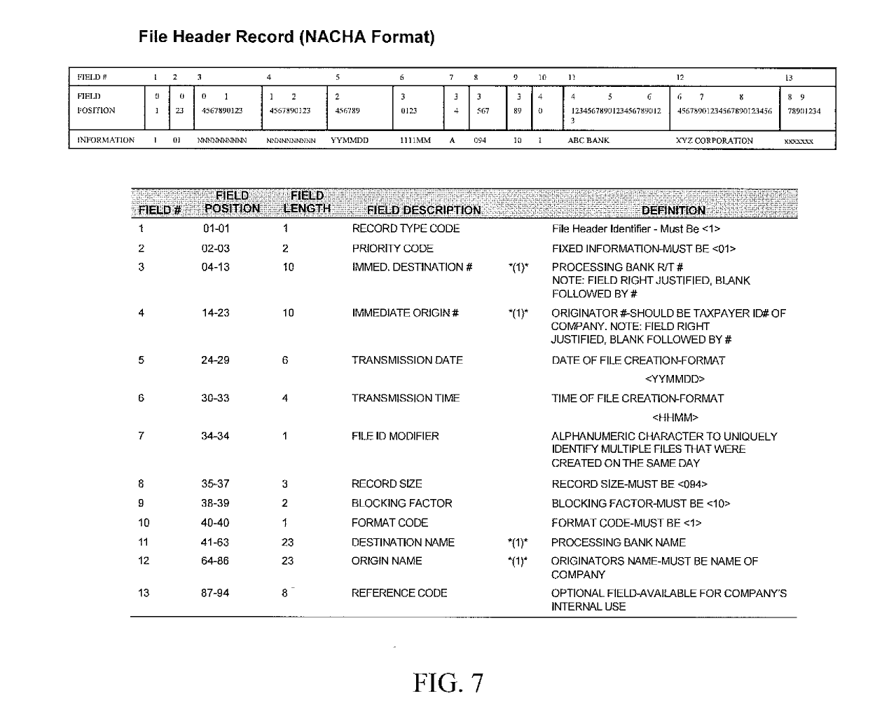

As shown in FIG. 5, the ACH file may begin with a file header record and end with a file control record. The file header record may identify the immediate origin, e.g., sending bank, and destination, e.g., the receiving bank, of the entries contained in the ACH file. The file header record also may include date, time, and file identification fields, which may be used to uniquely identify the ACH file. FIG. 7 illustrates an exemplary data format of a file header record of an ACH file according to NACHA. The file header record may include a plurality of fields each with designated position and length for indicating specific information of an ACH file. As will be discussed below, the reference code field, e.g., field #13, may be an optional field that may be used to include a dye pACH, e.g., unique key, to indicate a suspicious transaction. In particular, the reference code may include an identification of the batch and record numbers of transactions in the ACH file that are marked for tracking.

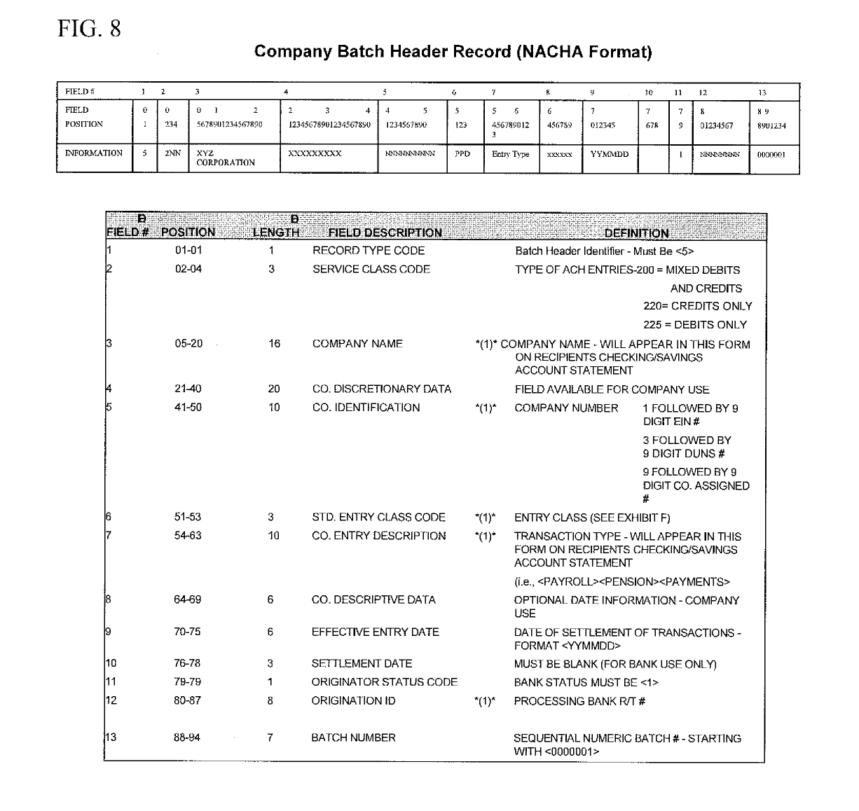

The ACH file may include a plurality of batches. Each batch may begin with a batch header record and end with a batch control record. The batch header record may identify the originator, e.g., fund originating bank, and describe the prearranged paperless debit or credit. For example, the reason for the transaction, e.g., “GAS BILL” or “SALARY” may be indicated in the batch control record. The batch control record also may include the routing and transit number of the Originating Depository Financial Institution (ODFI) for settlement, routing of returns, and other control purposes. Further, the batch header record also may include the intended effective entry date of all transactions within the batch. FIG. 8 illustrates an exemplary data format of the batch header record according to NACHA. The batch header record may include a plurality of fields each with designated position and length for indicating specific information of the batch. The company discretionary data field, e.g., field #4, may be used to attach dye pACH to identify and track suspicious transactions in the batch. For example, the discretionary data field may identify the entry record numbers of transactions that are marked for tracking.

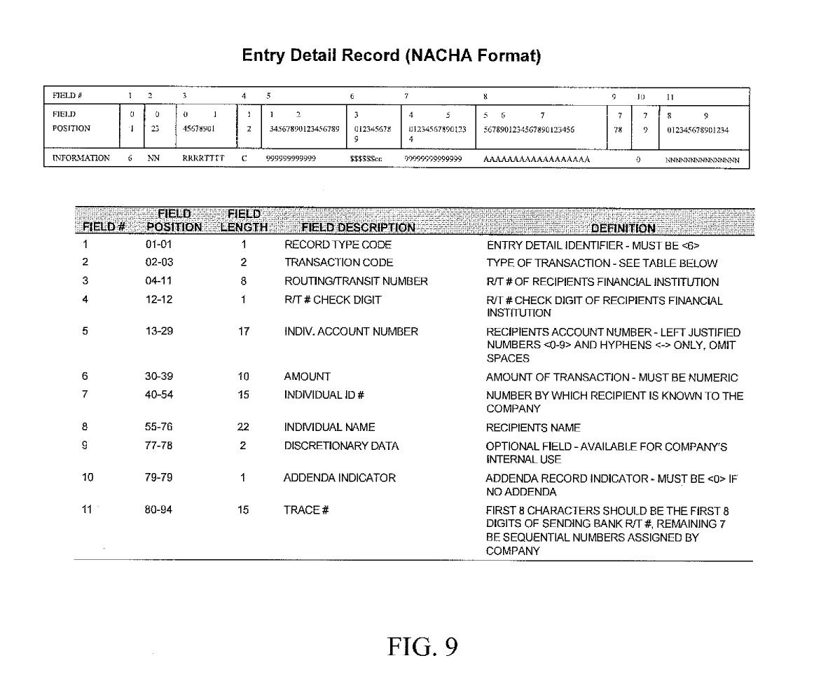

Each batch may include a plurality of entry detail records. The entry detail records may include individual Depository Financial Institution (DFI) account numbers, identification numbers, names, and debit, or credit amounts. FIG. 9 illustrates an exemplary data format of the entry detail record according to NACHA. The entry detail records may include a plurality of fields each with designated position and length for indicating specific information for the entry. The discretionary data field, e.g., field #9, may be used to attach dye pACH to identify and track suspicious transactions. For example, a unique key may be entered in the discretionary data field to indicate that the entry is marked with dye pACH for tracking the fund transfer.

Addenda indicator field, e.g., field #10, may indicate whether an addenda record is associated with the entry. The addenda record may be used by the originator, e.g., ODFI, to supply additional information about the entry detail record. The addenda record may be passed from the originator, ODFI, through the ACH operator, to the Receiving Depository Financial Institution (RDFI). The addenda record may be used to facilitate dye pACH for tracking fund transfers. For example, the addenda record may include a unique key to indicate that the associated entry is marked with dye pACH for fund tracking purpose.

The batch control record may be provided at the end of each batch. The batch control record may include the counts, hash totals, and total dollar controls for the entries in the batch. The file control record may be provided at the end of the ACH file. The file control record may include dollar, entry, and hash total accumulations from the batch control records in the ACH file. The file control record also may include counts of the number of blocks and number of batches within the ACH file.

At step 204, the receiving bank may determine whether the ACH file includes dye pACH. For example, the ACH file may include one or more entry detail records that are marked for fund tracking. The bank server of the receiving bank may read the ACH file to determine whether any entry detail records are marked for tracking. The format and convention for dye pACH marking may be agreed upon and predetermined by participating financial institutions. For example, based on the agreed format and convention, the dye pACH marking may be an unique key included in a marked entry detail record, e.g., in the discretionary data filed, or in an addenda record associated with the entry detail record.

In some embodiments, the dye pACH marking may be included in optional fields of file header record or batch header record. The marking may be a unique key or a description identifying the batch number and entry number of the marked entries. In another embodiment, certain batch number and/or entry number may specifically be designated for marked entries. For example, batch number “666” may be used to include transactions entries marked with dye pACH. Thus, all entries in batch number “666” may be set aside for special processing and tracking.

If the ACH file does not include dye pACH, the receiving bank may debit or credit funds to respective receiving accounts according to the transaction entries in the ACH file at step 210. If the ACH file contains one or more entries with dye pACH marking, the receiving bank may identify transaction entries marked with dye pACH at step 206. As noted above, based on a predetermined format or convention of the markings in the ACH file, the bank server of the receiving bank may access the specific field and record of the ACH file to determine whether an entry is marked with dye pACH for tracking.

At step 208, the bank server of the receiving bank may identify the receiving accounts of the transaction entries marked with dye pACH. For example, the bank server may determine the receiving account of the marked entry by reading the individual account number field of the marked entry detail record.

At step 212, the bank server of the receiving bank may send a dye pACH tracking information back to the sending bank to notify and confirm that the marked transaction has been received and processed. In an embodiment, the receiving bank may send the dye pACH tracking information back to the ACH server of NACHA, who may serve as the central entity that monitors the tracking of dye pACH. The tracking information may include a unique key that identify the particular fund that is being tracked. The tracking information also may include time, date, location, sending and receiving entities of the transaction. Thus, the previous bank or NACHA may organize the tracking information by their unique key and may arrange them in chronological order to indicate a transaction chain.

At step 214, the bank server of the receiving bank may mark the receiving accounts of the dye pACH transaction. In particular, the bank server may begin to monitor fund transfers to and from the marked receiving accounts. For example, the bank server may keep a transaction log including time, date, transaction type and amount of fund transfers to and from the marked receiving accounts.

At step 210, the bank server of the receiving bank may debit or credit funds to respective receiving accounts according to the transaction entries in the ACH file. In some embodiments, the bank server of the receiving bank may not deposit the fund into the receiving account if the fund is marked with dye pACH. For example, the bank server of the receiving bank may deposit the fund marked with dye pACH in a holding account associated with the receiving account. Thus, the fund marked with dye pACH may be set aside from the other funds already in the receiving account. Further, according to policy, the fund marked with dye pACH may or may not be accessible by the user of the receiving account.

By using the above process 200, a receiving bank may properly receive an ACH file including one or more transaction entries that are marked with dye pACH for fund tracking. In particular, the receiving bank may identify the marked transaction entries and the receiving accounts of the transaction entries, send a notification to the sending bank and/or NACHA regarding receipt of the dye pACH, and mark the receiving accounts of the dye pACH for proper monitoring.

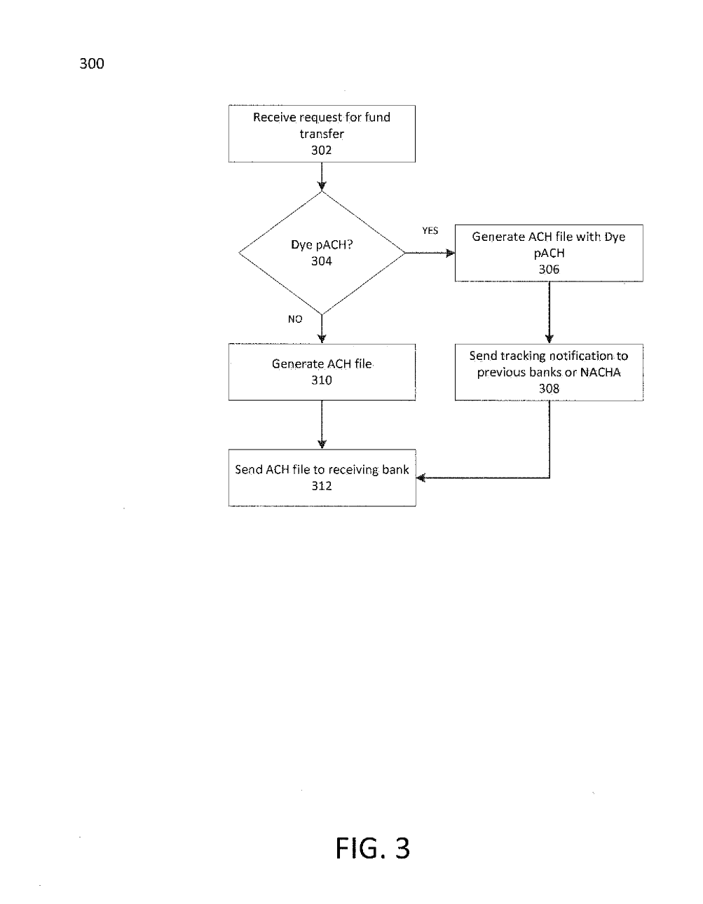

FIG. 3 is a flowchart showing a process 300 for sending an ACH transaction according to one embodiment. Process 300 may be executed by a server of a financial institution that is a participating member of the dye pACH tracking program. For example, each of bank server 120, 130, and 140, and payment provider server 170 may execute process 300 to generate and send an ACH file with dye pACH markings.

At step 302, a sending bank may receive a request for sending fund using ACH. For example, one or more account users of the sending bank may wish to send money from the sending bank. At step 304, the sending bank may determine if any of the fund transactions require dye pACH marking to track the flow of the fund. For example, a crime and fraud analyst at the sending bank may determine if any of the fund transfers are suspicious and require dye pACH marking for fund tracking.

The bank server of the sending bank also may determine if any of the fund transfers are associated with accounts already marked with dye pACH. For example, an account may be marked with dye pACH from receiving a fund transaction marked with dye pACH. Thus, funds transferred from an account marked with dye pACH may also be marked with dye pACH. The funds transfer from a marked account may selectively be marked based on different marking policies, such as first-in-first-out (FIFO), last-in-first-out (LIFO), or mark-all policies. In a FIFO policy, funds first come into an account also gets sent out first from the account. In the FIFO policy, a fund marked with dye pACH is sent out from the account after previously deposited funds are depleted. In a LIFO policy, funds last come into an account gets sent out first. In the LIFO policy, a fund marked with dye pACH is sent out from the account before previously deposited funds are depleted. In the mark-all policy, after a fund marked with dye-pACH is received by an account, all funds transfer from the account is marked with dye pACH. The marking policies may be pre-determined and agreed upon by participating ACH members.

If no dye pACH is to be included in the transactions, the sending bank may generate an ACH file without dye pACH at step 310. At step 312, the sending bank may forward the ACH file to receiving bank via NACHA. If dye pACH is to be included in one or more transaction entries, the sending bank may generate an ACH file with dye pACH at step 306. In particular, based on predetermine marking policy and/or convention of ACH members, the marking may be included in one or more predetermined locations of the ACH file to indicate dye pACH marking, as noted above.

At step 308, the sending bank may send a tracking notification to NACHA and/or to the bank where the marked fund was previously received from. Thus, the previous sending banks and/or NACHA may monitor and keep track of the transfer of the dye pACH fund when the dye pACH fund is being transferred. The tracking notification may include a unique key that identify the particular fund that is being tracked. The tracking notification also may include time, date, location, sending and receiving entities of the transaction. Thus, the previous bank or NACHA may organize the tracking notifications by their unique key and may arrange them in chronological order to indicate a transaction chain.

At step 312, the sending bank may send the ACH file to the receiving bank via NACHA. The ACH server of NACHA may sort and validate the transaction entries in the ACH file and forward the transaction entries to respective financial institutions according to the ACH file.

By using the above process 300, an ACH file including dye pACH markings for transaction entries may be generated to track suspicious transactions. Further, the sending of an ACH file with dye pACH markings may be notified to NACHA or previous sending banks to help monitor and keep track of the flow of funds marked with dye pACH.

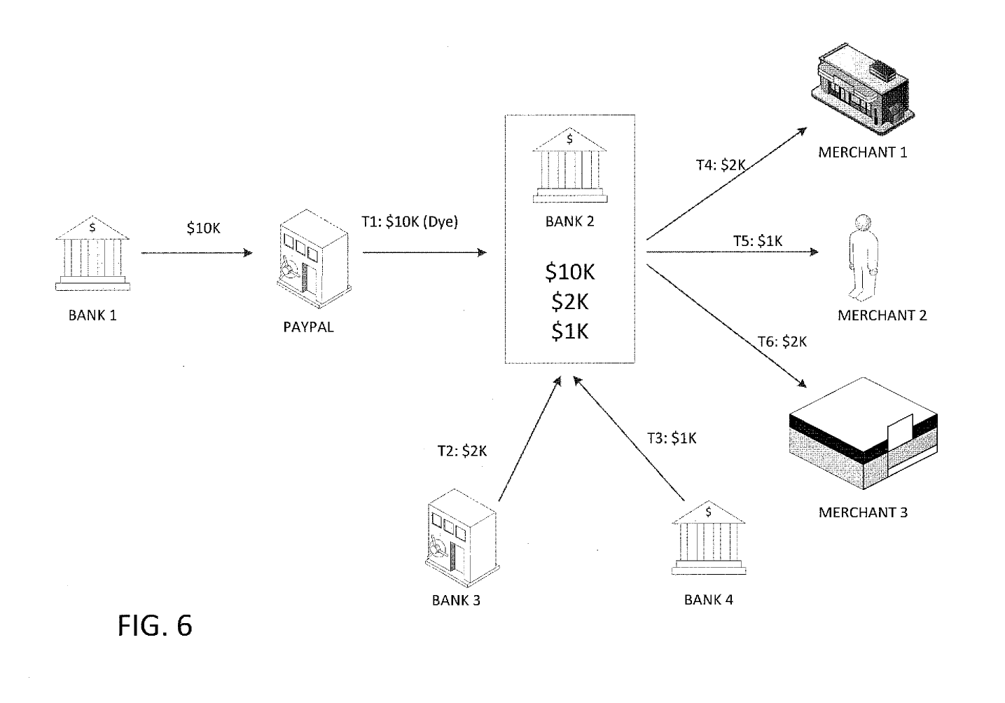

Referring now to FIG. 6, which illustrates an exemplary scenario in which the above processes 200 and 300 may be implemented.

A payment service provider, such as PayPal, Inc. may execute process 200 to receive a fund transfer of $10,000 from Bank 1. The anti-money laundering and fraud prevention unit at PayPal, Inc. may analyze the transaction from Bank 1 and determine that the fund transfer from Bank 1 is a possible money laundering scheme. Thus, the payment provider server at the payment service provider may identify the PayPal account that received the fund transfer from Bank 1 and mark the receiving PayPal account for fund tracking purpose. In particular, the payment service provider may begin to monitor transaction activities of the receiving PayPal account.

A user of the receiving PayPal account may request a fund transfer of $10,000 from the PayPal account to another account at Bank 2. The payment provider server of the payment service provider may execute process 300 to generate an ACH file including a transaction entry for the transfer of $10,000 from the PayPal account to another account at Bank 2. Because the PayPal account has been marked for monitoring, the ACH file may have a dye pACH marking indicating that the transaction entry is to be tracked. The marking may be a unique key attached to the transaction entry in the ACH file. In another embodiment, the transaction entry may be listed in a particular section of the ACH file designated for dye pACH transaction entries.

The payment service provider may send the ACH file to NACHA, which may then sort and balance the plurality of entries in the ACH file and send an ACH file including the $10,000 transaction from the PayPal user account to an account at Bank 2. The bank server at Bank 2 may execute process 200 to receive the ACH file and determine that the ACH file include a transaction entry marked with dye pACH. A bank server at Bank 2 may identify the account that receives the transaction of $10,000 marked with dye pACH and may designate the account for monitoring.

The bank server at Bank 2 later detects two additional transfers to the account at Bank 2 from Bank 3 and Bank 4. First, a transfer (T2) of $2,000 is made from Bank 3 into the account at Bank 2. Second, a transfer (T3) of $1,000 is made from Bank 4 into the account at Bank 2. Both of these fund transfers are not marked with dye pACH. As a result, the account at Bank 2 now holds a total of $13,000 including $10,000 that is marked with dye pACH and $3,000 that is not marked with dye pACH.

The user of the account at Bank 2 then requests a transfer of $2,000 (T4) to a Merchant 1. The bank server at Bank 2 may execute process 300 to transfer the $2,000 to Merchant 1. In particular, based on the tracking policy agreed upon by the participating ACH member banks, the bank server at Bank 2 may determine whether to mark the transfer of $2,000 with dye pACH. For example, in a mark-all policy, all transactions from a marked account are marked with dye pACH regardless of when the marked account first receives a dye pACH transaction. Thus, under the mark-all policy, the bank server at Bank 2 may mark the transaction entry of the $2,000 transfer to Merchant 1 with dye pACH. The bank server of Bank 2 also may send a tracking notification to the payment service provider about the transfer for tracking purpose.

In a FIFO policy, transactions that are received first also are sent out first. In this case, the $10,000 transfer marked with dye pACH was received before the $2,000 transfer and the $1,000 transfer that are not marked with dye pACH. Thus, the $10,000 marked with dye pACH will be sent out before the $3,000 without dye pACH. Under the FIFO policy, the $2,000 transfer to Merchant 1 is a portion of the $10,000 marked with dye pACH. Thus, the $2,000 transfer to Merchant 1 is marked with dye pACH to continue tracking of the money marked with dye pACH.

In a LIFO policy, transactions that are received last are sent out first. In this case, the $2,000 transfer to Merchant 1 is a portion of the $3,000 transfer received from Bank 3 and Bank 4, which are not marked with dye pACH. Thus, under LIFO policy, the $2,000 transfer to Merchant 1 is not marked with dye pACH.

The user of the account at Bank 2 then requests a transfer of $1,000 to Merchant 2 (T5). Accordingly, the bank server at Bank 2 also determines whether to mark the transfer of $1,000 to Merchant 2 with dye pACH. As noted above, under the mark-all policy, the transfer of $1,000 to Merchant 2 is marked with dye pACH. Under the FIFO policy, the transfer $1,000 to Merchant 2 also is marked with dye pACH. Under the LIFO policy, the transfer $1,000 is not marked with dye pACH.

The user of the account at Bank 2 later also requests a transfer of $2,000 to Merchant 3 (T6). The transfer of $2,000 to Merchant 3 is marked with dye pACH under the mark-all policy, the FIFO policy, and the LIFO policy. Merchants 1, 2, and 3 may all be participating members of dye pACH tracking. Thus, Merchants 1, 2, and 3 may send a notification to NACHA and/or previous financial institutions when a dye pACH transaction is received. Thus, the ACH server of NACHA or the bank servers of previous financial institutions may have a tracking record of the flow of the fund marked with dye pACH. Investigators or law enforcement may access the ACH server or one of the bank servers to obtain the tracking record of a specific fund using the fund's unique key. Thus, there is no need for the investigators of the law enforcement to track and visit each financial institution to track down the flow of a suspicious fund. Accordingly,

NACHA or the participating ACH member banks may set the tracking policy based on the patterns of criminal activities. For example, criminals typically move funds quickly through various banks for money laundering. Thus, a LIFO tracking policy may be suitable for tracking money laundering activities, because suspicious funds typically are deposited and sent out immediately with relative short holding period. If a more comprehensive picture of fund flow is desired, a mark-all tracking policy may be suitable to track all possible routes of fund flows.

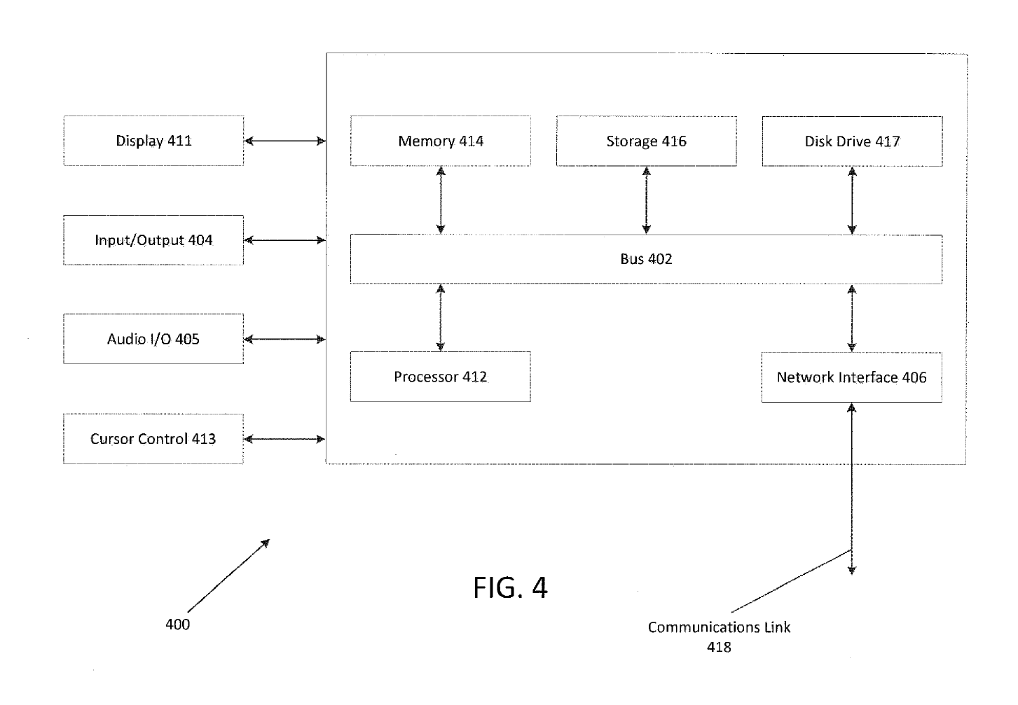

FIG. 4 is a block diagram of a computer system 400 suitable for implementing one or more embodiments of the present disclosure. In various implementations, the user device may comprise a personal computing device (e.g., smart phone, a computing tablet, a personal computer, laptop, PDA, Bluetooth device, key FOB, badge, etc.) capable of communicating with the network. The merchant and/or payment provider may utilize a network computing device (e.g., a network server) capable of communicating with the network. It should be appreciated that each of the devices utilized by users, merchants, and payment providers may be implemented as computer system 400 in a manner as follows.

Computer system 400 includes a bus 402 or other communication mechanism for communicating information data, signals, and information between various components of computer system 400. Components include an input/output (I/O) component 404 that processes a user action, such as selecting keys from a keypad/keyboard, selecting one or more buttons or links, etc., and sends a corresponding signal to bus 402. I/O component 404 may also include an output component, such as a display 411 and a cursor control 413 (such as a keyboard, keypad, mouse, etc.). An optional audio input/output component 405 may also be included to allow a user to use voice for inputting information by converting audio signals. Audio I/O component 405 may allow the user to hear audio.

A transceiver or network interface 406 transmits and receives signals between computer system 400 and other devices, such as another user device, a merchant server, or a payment provider server via network 360. In one embodiment, the transmission is wireless, although other transmission mediums and methods may also be suitable. A processor 412, which can be a micro-controller, digital signal processor (DSP), or other processing component, processes these various signals, such as for display on computer system 400 or transmission to other devices via a communication link 418. Processor 412 may also control transmission of information, such as cookies or IP addresses, to other devices.

Components of computer system 400 also include a system memory component 414 (e.g., RAM), a static storage component 416 (e.g., ROM), and/or a disk drive 417. Computer system 400 performs specific operations by processor 412 and other components by executing one or more sequences of instructions contained in system memory component 414. Logic may be encoded in a computer readable medium, which may refer to any medium that participates in providing instructions to processor 412 for execution. Such a medium may take many forms, including but not limited to, non-volatile media, volatile media, and transmission media. In various implementations, non-volatile media includes optical or magnetic disks, volatile media includes dynamic memory, such as system memory component 414, and transmission media includes coaxial cables, copper wire, and fiber optics, including wires that comprise bus 402. In one embodiment, the logic is encoded in non-transitory computer readable medium. In one example, transmission media may take the form of acoustic or light waves, such as those generated during radio wave, optical, and infrared data communications.

Some common forms of computer readable media includes, for example, floppy disk, flexible disk, hard disk, magnetic tape, any other magnetic medium, CD-ROM, any other optical medium, punch cards, paper tape, any other physical medium with patterns of holes, RAM, PROM, EEPROM, FLASH-EEPROM, any other memory chip or cartridge, or any other medium from which a computer is adapted to read.

In various embodiments of the present disclosure, execution of instruction sequences to practice the present disclosure may be performed by computer system 400. In various other embodiments of the present disclosure, a plurality of computer systems 400 coupled by communication link 418 to the network (e.g., such as a LAN, WLAN, PTSN, and/or various other wired or wireless networks, including telecommunications, mobile, and cellular phone networks) may perform instruction sequences to practice the present disclosure in coordination with one another.

Where applicable, various embodiments provided by the present disclosure may be implemented using hardware, software, or combinations of hardware and software. Also, where applicable, the various hardware components and/or software components set forth herein may be combined into composite components comprising software, hardware, and/or both without departing from the spirit of the present disclosure. Where applicable, the various hardware components and/or software components set forth herein may be separated into sub-components comprising software, hardware, or both without departing from the scope of the present disclosure. In addition, where applicable, it is contemplated that software components may be implemented as hardware components and vice-versa.

Software, in accordance with the present disclosure, such as program code and/or data, may be stored on one or more computer readable mediums. It is also contemplated that software identified herein may be implemented using one or more general purpose or specific purpose computers and/or computer systems, networked and/or otherwise. Where applicable, the ordering of various steps described herein may be changed, combined into composite steps, and/or separated into sub-steps to provide features described herein.

The foregoing disclosure is not intended to limit the present disclosure to the precise forms or particular fields of use disclosed. As such, it is contemplated that various alternate embodiments and/or modifications to the present disclosure, whether explicitly described or implied herein, are possible in light of the disclosure. Having thus described embodiments of the present disclosure, persons of ordinary skill in the art will recognize that changes may be made in form and detail without departing from the scope of the present disclosure. Thus, the present disclosure is limited only by the claims.

What is claimed is:

1. A device for facilitating fund transactions for a financial institution, the device comprising:
a hardware memory storing information about a user account at a financial institution, and
one or more processors in communication with the memory and adapted to:
receive a fund transaction via Automated Clearing House (ACH) designated for the user account;
determine whether the fund transaction is marked for tracking; and
process the fund transaction based on whether the fund transaction is marked for tracking.

2. The device of claim 1, wherein the fund transaction is sent electronically via an ACH file including an entry record instructing the fund transaction.

3. The device of claim 2, wherein the marking is a unique key listed in the entry record.

4. The device of claim 2, wherein the marked transaction is listed in a predetermined batch of entry records in the ACH file.

5. The device of claim 1, wherein the one or more processors are further adapted to send a tracking notification to a sending financial institution of the fund transaction when the fund transaction is marked for tracking.

6. The device of claim 1, wherein the one or more processors are further adapted to monitor other transactions of the user account when the fund transaction is marked for tracking.

7. A device for facilitating fund transactions for a financial institution, the device comprising:
a hardware memory storing information about a user account at a financial institution, and
one or more processors in communication with the memory and adapted to:
receive a request for a fund transaction using the user account;
determine whether the fund transaction is to be marked for tracking;
generate an Automated Clearing House (ACH) file including a transaction entry indicating the fund transaction using the user account;
marking the transaction entry in the ACH file for tracking when the fund transaction is to be marked; and
sending the ACH file to a receiving financial institution via National Automated Clearing House Association (NACHA).

8. The device of claim 7, wherein the marking is a unique key listed in the transaction entry of the ACH file.

9. The device of claim 7, wherein the marked transaction is listed in a predetermined batch in the ACH file.

10. The device of claim 7, wherein the one or more processors are further adapted to send a tracking notification to a financial institution from which the fund was previously received when the fund transaction is marked for tracking.

11. The device of claim 7, wherein the fund transaction is determined to be marked for tracking when the user account has a fund that is marked.

12. The device of claim 7, wherein the fund transaction is determined to be marked for tracking based on a timing of when a marked fund was received by the user account.

13. The device of claim 12, wherein the fund is marked based on a first-in-first-out tracking policy.

14. The device of claim 12, wherein the fund is marked based on a last-in-first-out tracking policy.

15. A method for facilitating tracking of fund transactions, the method comprising:
receiving, by a processor, a request for a fund transaction using a user account;
determining, by the processor, whether the fund transaction is to be marked for tracking;
generating, by the processor, an Automated Clearing House (ACH) file including a transaction entry indicating the fund transaction using the user account;
marking, by the processor, the transaction entry in the ACH file for tracking when the fund transaction is to be marked; and
sending, by the processor, the ACH file to a receiving financial institution via National Automated Clearing House Association (NACHA).

16. The method of claim 15, wherein the marking is a unique key listed in the transaction entry of the ACH file.

17. The method of claim 15, wherein the marked transaction is listed in a predetermined batch in the ACH file.

18. The method of claim 15 further comprising: sending a tracking notification to a financial institution from which the fund was previously received when the fund transaction is marked for tracking.

19. The method of claim 15, wherein the fund transaction is determined to be marked for tracking when the user account has a fund that is marked.

20. The method of claim 7, wherein the fund transaction is determined to be marked for tracking based on a timing of when a marked fund was received by the user account.
